(19) United States
(12) Patent Application Publication
(10) Pub. No.: US 2006/0157512 A1
(43) Pub. Date: Jul. 20, 2006

(54) Dispensing device with piston pump

(75) Inventor: Edgar Ivo Maria van der Heijden, Broek op Langedijk (NL)

Correspondence Address: HOFFMANN & BARON, LLP, 6900 JERICHO TURNPIKE, SYOSSET, NY, 11791, US

(73) Assignee: Airspray N.V.

(21) Appl. No.: 11/324,896

(22) Filed: Jan. 4, 2006

(30) Foreign Application Priority Data
Jan. 4, 2005 (NL) 1027949

(51) Int. Cl. B67D 5/58

(52) U.S. Cl. 222/190

(57) ABSTRACT

The invention relates to a foam-dispensing device for dispensing a foam, comprising a manually operated pump assembly. The pump assembly comprises a liquid piston pump for pumping the liquid, and an air pump for pumping air, the liquid and air to be pumped being mixed together to form a foam which is dispensed through a dispensing aperture. The liquid piston pump comprises a pump housing, for example a cylinder, a liquid piston which is movable telescopically in the pump housing, and one or more sealing elements to be fixed on the liquid piston in order to seal the liquid piston in the pump housing. The liquid piston comprises at least two locations for fixing the one or more sealing elements. The invention further relates to a kit for producing a piston with one or more sealing elements for such a dispensing device, and a method for producing a piston pump for such a dispensing device.

### SUBJECT OF THE INVENTION

The invention relates to a foam-dispensing device. The invention further relates to a dispensing device, a kit for assembling a piston for such a foam-dispensing device and a method for producing such a device.

### BACKGROUND OF THE INVENTION

Dispensing devices are generally used for pumping a liquid out of a reservoir. More particularly, the invention relates to a manually operated dispensing device for dispensing a foam, which device is preferably held in the hand during operation. In such a foam-dispensing device, in addition to the piston pump for pumping a liquid, an air pump is provided for pumping air. The pumped air and liquid are mixed together to form a foam before dispensing. Such foam-dispensing devices are also generally known.

The known piston pump is provided with a seal which contacts in a sealing manner to pump housing. In a known embodiment this seal is moulded on as part of the piston. In another known embodiment of a piston pump an O-ring or the like is fixed in a recess provided for the purpose in the piston.

The degree of sealing between the piston and the pump housing is dependent not only upon the shape, the material and the flexibility of the piston seal, but also upon the liquid being pumped with the piston pump. It is possible for a certain type of seal to be suitable for sealing a piston pump for a particular liquid, while the same seal is less suitable, or is even unsuitable, for another liquid.

It is remarked that in particular very thin liquids or liquids which tend to stick to or cake on the parts of the piston pump can cause problems with respect to the sealing. Such liquids can be, for example, soaps which have been made suitable for forming a foam.

A disadvantage of the known dispensing devices is that after production of the piston the seal of the liquid pump is difficult or impossible to adapt to the requirements of the liquid for which the piston pump is being used.

### OBJECT OF THE INVENTION

The object of the present invention is to provide a dispensing device, in particular a foam-dispensing device, which is easy to adapt to the liquid to be pumped with the piston pump.

### SUMMARY OF THE INVENTION

The object of the invention is achieved with a dispensing device according to claim 1.

By providing at least two locations on the piston for the fixing of one or more sealing elements, a very flexible facility is created for adapting the seal used on the piston to the liquid to be pumped with the piston pump.

It is possible to provide several possibly different types of sealing elements, from which a choice can be made on the basis of the liquid which is to be dispensed with the piston pump. Such a choice involves, for example, choosing from sealing elements which can be fitted in different positions on the location on the piston, or choosing from sealing elements made of different materials or having a different shape and/or being of different rigidities.

In a preferred embodiment the piston comprises three locations for fixing the one or more sealing elements. The presence of three locations generally gives sufficient freedom for fixing sealing elements for a seal suitable for the liquids commonly used.

At least one of the one or more sealing elements preferably comprises a lip which at least partially extends in a direction of movement of the piston. Such a lip has been found to be suitable for resting in a sealing manner against a wall of the pump housing, the shape also providing a scraping effect, which is particularly effective in preventing liquid residues from clinging to the wall.

The lip can advantageously extend either in the direction of the pump stroke (on compression of the pump chamber) or in the direction of the return stroke (on expansion of the pump chamber). In the first case, the scraping action will have an effect in particular on the liquid situated on the inside wall of the pump housing on the side of the liquid pump chamber, while in the second case the scraping action will have an effect in particular on liquid which has come from the outside into the pump housing on the side of the piston facing away from the pump chamber.

It is advantageously possible to provide a piston with two sealing elements, each with a lip, one of the two lips extending in the direction of the pump stroke, in other words in the direction of the pump chamber, while the other lip extends in the opposite direction, i.e. in the direction of the return stroke, or facing away from the pump chamber.

The dispensing device according to the invention is advantageously suitable for a dispensing device for foam. Liquids which are suitable for forming a foam in a dispensing device are in fact generally thin. Such a thin liquid can relatively easily pass a seal. Placing several seals one after the other, for example three lips in a row, now gives better protection against leakage because, if the thin liquid passes the first lip, the liquid is still in a protected environment through the presence of the next lip.

More particularly, the dispensing device is suitable for a foam-dispensing device with a liquid pump and an air pump placed concentrically around the liquid pump, a side of the liquid piston facing away from the liquid pump chamber at least partially delimiting the air pump chamber. If a quantity of liquid in such a liquid pump leaks through the seal, that liquid will run into the air pump chamber.

Now in a foam pump air is pumped at 7 to 11 times the volume of the liquid pumped (can also sometimes be more or less than that). During the pumping process this air also moves (in a turbulent manner) past the liquid piston, and the air causes a drying-out effect on the liquid present in the air pump chamber. This means that, if there is slight leakage, the already thin liquid dries out more quickly, which can result in the liquid pump running stiffly. Such stiff running can be prevented by providing an improved seal according to the invention.

The invention further relates to a kit for producing a piston with one or more sealing elements for a dispensing device, comprising at least one piston with two or more locations for fixing the one or more sealing elements, and a number of sealing elements from which the one or more sealing elements to be fixed on the locations of the piston can be selected on the basis of a liquid to be pumped with the piston pump. With such a kit, the piston can be adapted in a simple manner during the assembly, in order to provide a suitable piston seal for the liquid to be pumped with the piston pump, by correctly selecting and placing one or more sealing elements on the piston.

The invention also relates to a method for producing a piston pump for a dispensing device for dispensing at least one liquid, which piston pump comprises a piston, a pump housing and one or more sealing elements for sealing the piston in the pump housing, the piston having at least two locations for fixing the one or more sealing elements, which is characterized by the step:

selecting and fitting one or more sealing elements on at least one of the two or more locations.

The one or more sealing elements are advantageously chosen from several types of sealing elements. These types can differ, for example, in the material from which the sealing element is made, or the shape or the flexibility of the material. If desired, a choice can also be made regarding the position in which the sealing element is placed on a location of the piston.

### DESCRIPTION OF THE DRAWINGS

Further advantages and features of the invention will be explained in greater detail below with reference to a drawing, in which:

FIG. 1 shows a foam pump with a piston designed according to the invention;

FIGS. 2a and 2b show a piston without sealing elements fixed on it, in top view and in cross section respectively; and

FIGS. 3a, 3b, 3c, 3d and 3e show the piston of FIG. 2 with one, two or three sealing elements fixed on it.

### DETAILED DESCRIPTION OF THE PREFERRED EMBODIMENTS

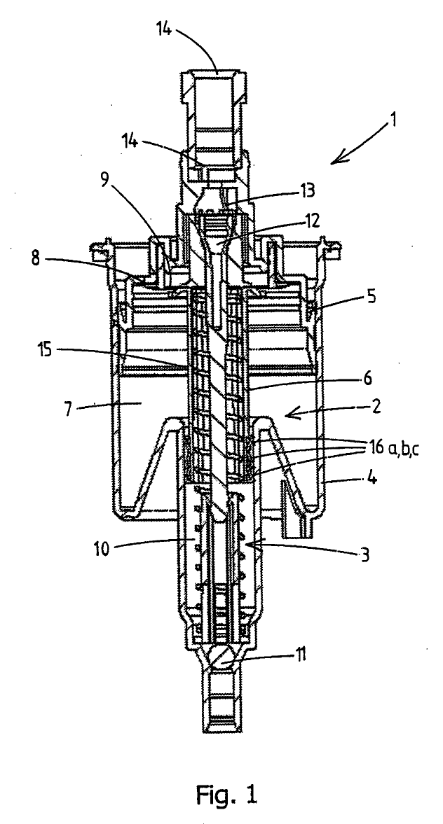

FIG. 1 shows a foam pump for dispensing a foam, which foam pump is indicated in its entirety by reference numeral 1. The foam pump 1 can be fixed by means of a fixing collar on a reservoir in which the liquid to be pumped is stored. The foam pump comprises an air pump 2 and a liquid pump 3. The pump housing of both the air pump 2 and the liquid pump 3 is formed by a double cylinder 4, in which an air piston 5 and a liquid piston 6 to be operated with a common control button (not shown) are fitted.

The air piston 5 together with a part of the double cylinder 4 and the liquid piston forms an air pump chamber 7, by means of which air can be pumped by the air piston 5 performing a telescopic movement relative to the double cylinder 4. This pumping action is made possible by the fact that the air pump 2 is provided with an inlet valve 8 and an outlet valve 9.

In a corresponding manner, the liquid piston 6 together with a part of the double cylinder 4 forms a liquid pump chamber 10, which is compressed and expanded through the telescopic movement of the liquid piston 6 in the double cylinder in order to obtain a pumping action. The liquid pump further comprises an inlet valve 11 and an outlet valve 12. By means of the pumping action, during a stroke which expands the liquid pump chamber, liquid is sucked up from a reservoir connected to the foam pump 1, and in a subsequent compressing stroke said liquid is pumped up through the hollow liquid piston 6 past the outlet valve 12.

Here the liquid goes into a mixing chamber 13 and is mixed with the air pumped out of the air pump chamber 7 in the same compressing stroke. The liquid-air mixture is subsequently guided through two sieve-like elements 14, so that a firm foam is formed. This foam is guided through a dispensing channel provided in the common control button (not shown) to a dispensing aperture, where the foam is dispensed.

Further details and the operation of the foam pump 1 shown, with the exception of the design of the piston, as will be explained below, are described in, for example, European Patent EP 0613728 B1, the content of which is included herein by reference. The liquid piston 6 used in this patent is made up of a single element, which also forms the seal with the inside wall of the double cylinder.

The liquid piston 6 of the liquid pump 3 is made up of a cylindrical piston 15 and in this case three separate sealing elements 16a, 16b and 16c, which are fitted on three locations 15a, 15b and 15c of the piston 15.

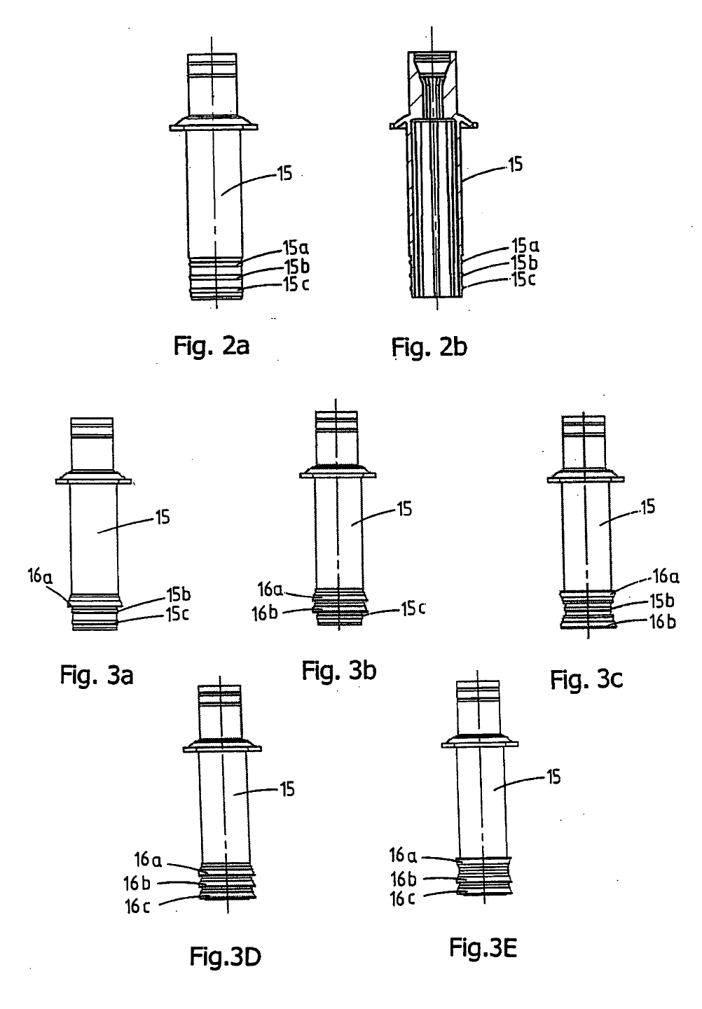

The cylindrical piston 15 is shown separately in FIG. 2. The three locations 15a, 15b and 15c are formed by three ribs extending around the periphery of the piston 15. The presence of these ribs means that one or more sealing elements 16a, 16b, 16c can be fixed on the piston 15. Other suitable means for fixing the one or more sealing elements 16a, 16b, 16c, such as recesses, screw thread or other types of fixing means, can also be used.

Depending on the liquid which is to be pumped with the liquid pump, one or more different sealing elements or the same sealing elements 16a, 16b, 16c can be fitted on the piston 15. If desired, these sealing elements 16a, 16b, 16c may be of different shapes, materials and/or flexibility. It is also possible to fix the sealing elements in different positions or orientations on the piston 15.

FIG. 3 shows five examples of sealing elements 16a, 16b, 16c fitted on the piston 15. Use has been made of sealing elements 16a, 16b, 16c which have the same shape.

In FIG. 3a a sealing element 16a is fitted on a location 15a. The sealing element 16a is in the form of a cylindrical body provided with a groove which connects substantially in a form fit to the rib of the piston, a lip being moulded onto said cylindrical body, which lip projects radially outwards and after fitting extends in the direction of the liquid pump chamber 10. Owing to the presence of the lip 10, the sealing element acquires a scraping action during its movement along the inside wall of the double cylinder 4.

In FIG. 3b, in addition to the first sealing element 16a as shown in FIG. 3a, a second sealing element 16b is fitted on the location 15b in order to obtain an improved seal between the piston 15 and the wall of the double cylinder. The second sealing element 16b is placed in the same orientation (or position) as the first sealing element, so that the moulded-on lip points in the direction of the liquid pump chamber 10.

Fitting a second sealing element 16b gives an improved seal between the liquid piston 6 and the inside wall of the double cylinder 4, so that in particular liquid which runs past the first sealing element does not go directly into the air pump chamber 7. It is important to prevent this from happening because the liquid can dry out quickly in the air pump chamber 7 because of the turbulent air flow arising in this air pump chamber during pumping of the air. The liquid drying out because of the turbulent air flow can then cause the liquid piston 6 to run stiffly, in particular if the drying liquid sticks to the inside wall of the double cylinder 4 or the sealing element 16a, 16b or 16c.

In order to obtain an even better seal between the liquid piston and the double cylinder 4, it is possible, for example, to fit more sealing elements on the piston 15, as is shown, for example, in FIGS. 3d and 3e.

FIG. 3c shows an embodiment in which two sealing elements 16a and 16b are again fitted on the piston 15. However, in this case a first sealing element 16a is fitted in the opposite position on location 15a, i.e. with the lip extending in the direction facing away from the liquid pump chamber 10, and the second sealing element 16b is fitted on the third location 15c in the position shown in FIGS. 3a and 3b. In this way the scraping effect obtained by means of the lip of the sealing elements 16a and 16b is obtained in both directions. The lip facing away from the liquid pump chamber can be advantageous in particular if liquid is able to run down from the other side, in this case the air pump chamber 7. The presence of the sealing element 16a with its lip in the direction described ensures that this liquid is prevented by the seal from going into the liquid pump chamber 10.

FIGS. 3d and 3e show two embodiments in which a sealing element 16a, 16b and 16c respectively is fitted on each of the three locations 15a, 15b, 15c of the piston 15.

In the embodiment of FIG. 3d all three of the sealing elements 16a, 16b and 16c are fitted in the same orientation, in such a way that, after fitting, the lip of each of the sealing elements 16a, 16b, 16c faces the liquid pump chamber. On the other hand, in the embodiment of FIG. 3e the fixing element 16a fitted on location 15a is fitted in an orientation opposite to that of the other two sealing elements 16b, 16c, i.e. after fitting of the piston 15, with the lip facing away from the liquid pump chamber.

It will be clear to the person skilled in the art that providing two or more locations, in the case illustrated three locations 15a, 15b, 15c, for fixing sealing elements gives great freedom in the provision of a seal suitable for a particular liquid or application. The choice can include the number of sealing elements 16a, 16b, 16c, the shape of the sealing elements, the material from which those sealing elements are made and their rigidity, the orientation in which the sealing elements are fixed on the piston, etc.

All sealing elements shown in the figures have the same shape. It will, no doubt, be clear that many other suitable shapes are possible, such as straight or torus-shaped seals without lips, sealing elements with a straight lip extending radially outwards and sealing elements with several lips, or any other shape which is suitable as a seal. The sealing elements can be made of any suitable material that is known, for example, as sealing, in which case it is given the appropriate rigidity.

The piston of the dispensing device according to the invention gives the user great freedom in the production of suitable seals. If desired, a possible seal suitable for a particular liquid or application can be found on the basis of experimental research. The seal decided upon in this way can then be mass-produced. A sealing piston obtained in this way is also considered to fall within the scope of the invention.

1. Foam-dispensing device for dispensing a foam, comprising a manually operated pump assembly, which pump assembly comprises a liquid piston pump for pumping the liquid, and an air pump for pumping air, the liquid and air to be pumped being mixed together to form a foam which is dispensed through a dispensing aperture, the liquid piston pump comprising a pump housing, for example a cylinder, a liquid piston which is movable telescopically in the pump housing, and one or more sealing elements to be fixed on the liquid piston in order to seal the liquid piston in the pump housing, while the liquid piston comprises at least two locations for fixing the one or more sealing elements.

2. Foam-dispensing device according to claim 1, in which the liquid piston pump comprises at least one sealing element which can be fixed in at least two positions on one of the locations of the liquid piston.

3. Foam-dispensing device according to claim 1, in which the liquid piston comprises two or more sealing elements which are fixed on the two or more locations of the liquid piston.

4. Foam-dispensing device according to claim 3, in which at least two of the two or more sealing elements are made of a different material.

5. Foam-dispensing device according to claim 3, in which at least two of the two or more sealing elements are of a different shape.

6. Foam-dispensing device according to claim 3, in which at least two of the two or more sealing elements are of different rigidities.

7. Foam-dispensing device according to claim 1, in which at least one of the one or more sealing elements comprises a lip which at least partially extends in a direction of movement of the liquid piston.

8. Foam-dispensing device according to claim 1, in which at least one of the two or more locations comprises a rib for fixing the one or more sealing elements.

9. Foam-dispensing device according to claim 1, in which at least one of the two or more locations comprises a recess for fixing the one or more sealing elements.

10. Foam-dispensing device according to claim 1, in which the air pump is a piston pump which is disposed concentrically relative to the liquid pump.

11. Dispensing device for dispensing at least one liquid, comprising at least one manually operated piston pump for pumping the liquid, which piston pump comprises a pump housing, in particular a cylinder, and a piston which is movable telescopically in the pump housing, and one or more sealing elements to be fixed on the piston in order to seal the piston in the pump housing, while the piston comprises at least two locations for fixing the one or more sealing elements.

12. Dispensing device according to claim 11, wherein the piston pump comprises at least one sealing element, which can be fixed in at least two positions on one of the locations of the piston.

13. Dispensing device according to claim 11, wherein the piston comprises two or more sealing elements which are fixed on the two or more locations of the piston.

14. Dispensing device according to claim 13, wherein at least two of the two or more sealing elements are made of a different material.

15. Dispensing device according to claim 13, wherein at least two of the two or more sealing elements are of a different shape.

16. Dispensing device according to claim 13, wherein at least two of the two or more sealing elements are of different rigidities.

17. Dispensing device according to claim 11, wherein at least one of the one or more sealing elements comprises a lip which extends at least partially in a direction of movement of the piston.

18. Dispensing device according to claim 11, wherein at least one of the two or more locations comprises a rib for fixing the one or more fixing elements.

19. Dispensing device according to claim 11, wherein at least one of the two or more locations comprises a recess for fixing the one or more fixing elements.

20. Kit for producing a piston with one or more sealing elements for a foam-dispensing device according to claim 1, comprising a piston with two or more locations for fixing the one or more fixing elements, and a number of sealing elements from which the one or more sealing elements to be fixed on the locations of the piston can be selected on the basis of a liquid to be pumped with the piston pump.

21. Kit for producing a piston with one or more sealing elements for a dispensing device according to claim 11, comprising a piston with two or more locations for fixing the one or more sealing elements, and a number of sealing elements from which the one or more sealing elements to be fixed on the locations of the piston can be selected on the basis of a liquid to be pumped with the piston pump.

22. Method for producing a piston pump for a dispensing device for dispensing at least one liquid, in particular a foam-dispensing device for dispensing a foam, in which the piston pump comprises a piston, a pump housing and one or more sealing elements for sealing the piston in the pump housing, in which the piston comprises at least two locations for fixing the one or more sealing elements, and in which the method comprises the step of selecting and fitting one or more sealing elements on at least one of the two or more locations.

23. Method according to claim 22, in which the selection is made from several types of sealing elements:

24. Method according to claim 22, in which the selection comprises determining the position of the sealing element in which the sealing element is fitted on one of the at least two locations on the piston.

25. Method according to claim 22, in which the selection comprises choosing one or more fixing elements and possibly determining their orientation on the basis of the liquid to be pumped.

26. Method according to claim 22, in which the selection step is repeated on an experimental basis until a suitable seal is found, the suitable seal then being mass-produced for use in the dispensing device.
